(19) United States
(12) Patent Application Publication
(10) Pub. No.: US 2017/0086537 A1
(43) Pub. Date: Mar. 30, 2017

(54) ARTICULATING LINKS WITH VIRTUAL PIVOT

(71) Applicant: Apple Inc., Cupertino, CA (US)

(72) Inventors: Daniele de Iuliis, Cupertino, CA (US); Michael J. Webb, Scotts Valley, CA (US)

(21) Appl. No.: 15/256,860

(22) Filed: Sep. 6, 2016

Related U.S. Application Data
(60) Provisional application No. 62/233,470, filed on Sep. 28, 2015.

(51) Int. Cl. A44C 5/02; A44C 5/22; G04B 37/14; A44C 5/00

(52) U.S. Cl. CPC A44C 5/027; A44C 5/0053; A44C 5/22; G04B 37/1486

(57) ABSTRACT

A band for a wearable electronic device is disclosed. The band comprises a first link body and a second link body, and a pair of joints joining the first link body to the second link body. Each joint comprises a first arm pivotally coupled to the first link body at a first end of the first arm, and a second arm pivotally coupled to the second link body at a first end of the second arm. A second end of the first arm is pivotally coupled to a second end of the second arm.

### CROSS-REFERENCE TO RELATED APPLICATION

This application is a nonprovisional patent application of U.S. Provisional Patent Application No. 62/233,470, filed Sep. 28, 2015 and titled “Articulating Links with Virtual Pivot,” the disclosure of which is hereby incorporated herein by reference in its entirety.

### FIELD

The disclosure relates generally to electronic devices, and more particularly to links for bands that are used to secure devices to persons or objects.

### BACKGROUND

Conventional wearable devices, such as wristwatches, include bands that couple the device to a user. For example, a conventional wristwatch typically includes a band that attaches the watch to a user's wrist. Some bands are composed of multiple articulating links that allow the band to flex to match the shape and contours of a user's wrist. Such bands are sometimes known as “bracelet bands.”

### SUMMARY

A band for a wearable electronic device comprises a first link body, a second link body, and a pair of joints joining the first link body to the second link body. Each joint comprises a first arm pivotally coupled to the first link body at a first end of the first arm, and a second arm pivotally coupled to the second link body at a first end of the second arm. A second end of the first arm is pivotally coupled to a second end of the second arm.

A wearable electronic device comprises an electronic device housing and a band connected to the electronic device housing. The band comprises a first link configured to pivot relative to a second link about a link pivot axis, and a first pair of arms pivotally coupled to the first link, each respective arm of the first pair of arms configured to pivot relative to the first link about a respective joint pivot axis that is not parallel to the link pivot axis. The band also comprises a second pair of arms pivotally coupled to the second link, each respective arm of the second pair of arms pivotally coupled to a respective arm of the first pair of arms to couple the first link to the second link.

A band for a wearable electronic device comprises a first link body, a second link body set apart from the first link body by a gap, and a pair of articulating joints coupling the first link body to the second link body and configured to allow the first link body to pivot relative to the second link body about a pivot axis passing through the gap.

### BRIEF DESCRIPTION OF THE DRAWINGS

The disclosure will be readily understood by the following detailed description in conjunction with the accompanying drawings, wherein like reference numerals designate like structural elements,.

FIG. 1 shows an example wearable device attached to a wearer.

FIG. 2 shows a partial view of a side of the wearable device.

FIG. 3 shows a top view of a pair of links for a band for a wearable device.

FIG. 4 shows a front view of the pair of links of FIG. 3.

FIG. 5 shows a side view of the pair of links of FIG. 3.

FIG. 6 shows a top view of the pair of links of FIG. 3 in a pivoted orientation.

FIG. 7 shows a front view of the pair of links of FIG. 6.

FIG. 8 shows a side view of the pair of links of FIG. 6.

FIG. 9 shows a partial view of a joint for coupling links to each other.

FIG. 10 shows a partial cross-sectional view of the joint of FIG. 9, taken along line 10-10 in FIG. 9.

FIG. 11 shows a portion of a band for a wearable device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Wearable devices, such as watches, are typically secured to a user or to an object with a band. Some bands are composed of multiple links that allow the band to flex to conform to a wearer's wrist. Discussed herein are articulable watch band links and/or link assemblies that pivot with respect to one another about a virtual pivot axis. A virtual pivot axis is an axis about which two links pivot with respect to one another, but which is not coincident with a pivot axis of a physical structure, linkage, or joint. For example, as described herein with respect to various embodiments, a virtual pivot axis may be formed by joining links (or link bodies) with mechanisms that have multiple degrees of rotational and/or translational freedom. Such mechanisms may have multiple members that can articulate, pivot, swivel, translate, or otherwise move relative to one another in order to allow adjacent links to pivot about a virtual pivot axis. In mechanisms that have pivotally coupled members, the pivot axis (or axes) of the mechanism may not be coincident with the axis about which the links ultimately pivot with respect to each other (e.g., the virtual pivot axis).

A virtual pivot axis in the present discussion may or may not be a fixed virtual pivot axis. In a fixed virtual pivot axis, the relative motion of the links with respect to one another may mimic the rotational movement that would occur with a single physical pivot axis (e.g., one link may follow a circular rotational path with respect to another link). On the other hand, in a non-fixed or moving virtual pivot axis, the virtual pivot axis may move (relative to the links) as the links are articulated with respect to one another. The moving virtual pivot axis may result in the links both rotating and translating with respect to one another as the links are articulated. Links that rotate and translate (or that otherwise exhibit a moving virtual pivot axis) are considered to pivot about a virtual pivot axis even though the relative motion of the links may not be exclusively rotational.

In the following figures and description, similar instances of particular components or features may be designated by additional indicators appended to the element number. For example, particular instances of links may be designated 200-1, 200-2, etc. References to an element number without any additional indicator (e.g., the link 200) apply to any or all instances of that component or feature, and references to an element number with an additional indicator (e.g., the link 200-1) apply to a particular instance of that component or feature. Moreover, any discussion related to an individual instance of a component or feature (e.g., the link 200-1) may also apply to other instances of that component (e.g., the link 200-2).

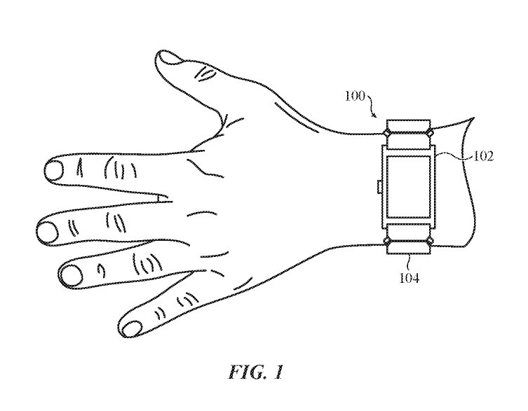

FIG. 1 shows a wearable device 100 (also referred to as “device 100”). As shown, the wearable device 100 is a wearable electronic device, such as a smartwatch. In other embodiments, the device 100 is an electrical or mechanical wristwatch, a health monitoring device, a wrist-worn computing device, a timekeeping device, a stopwatch, or the like. The device 100 (e.g., a wearable electronic device) may include a housing 102 that forms an outer surface or partial outer surface and protective case for the internal components of the device 100. The housing 102 may also include mounting features formed on opposite ends to connect a wearable band 104 (also referred to as “band 104”) to the housing 102.

The device 100 may also include a display 105 coupled to the housing 102. The display 105 may be a touch-sensitive display configured to accept inputs (e.g., touch inputs) and present user interfaces (and other visual outputs) to a user. The device 100 (e.g., the wearable electronic device) may also include a processor (not shown) and memory (not shown) coupled to the display 105 and/or other components of the device 100 to provide computing and processing functionality. Such functionality includes biometric monitoring, software execution, detecting environmental and/or user supplied inputs, providing outputs, and the like.

The band 104 may be composed of or otherwise include multiple links or link assemblies that are coupled to one another to form all or a portion of the band 104. As noted above, the band 104 may include a plurality of articulable watch band links and/or link assemblies that pivot or articulate with respect to one another about a virtual pivot axis to allow the band 104 to flex to conform to a wearer's wrist (or other body part or object). The band 104 may include a clasp (not shown) or other mechanism between two portions of the band 104. The clasp may allow the band 104 to be at least partially opened (e.g., expanded), for example, to allow the device 100 to be attached to a user (e.g., the user's wrist).

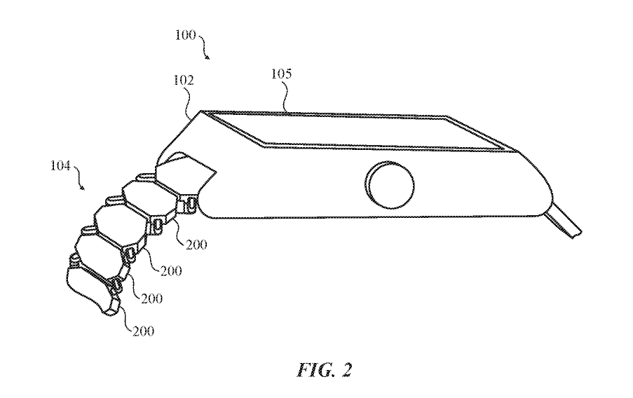

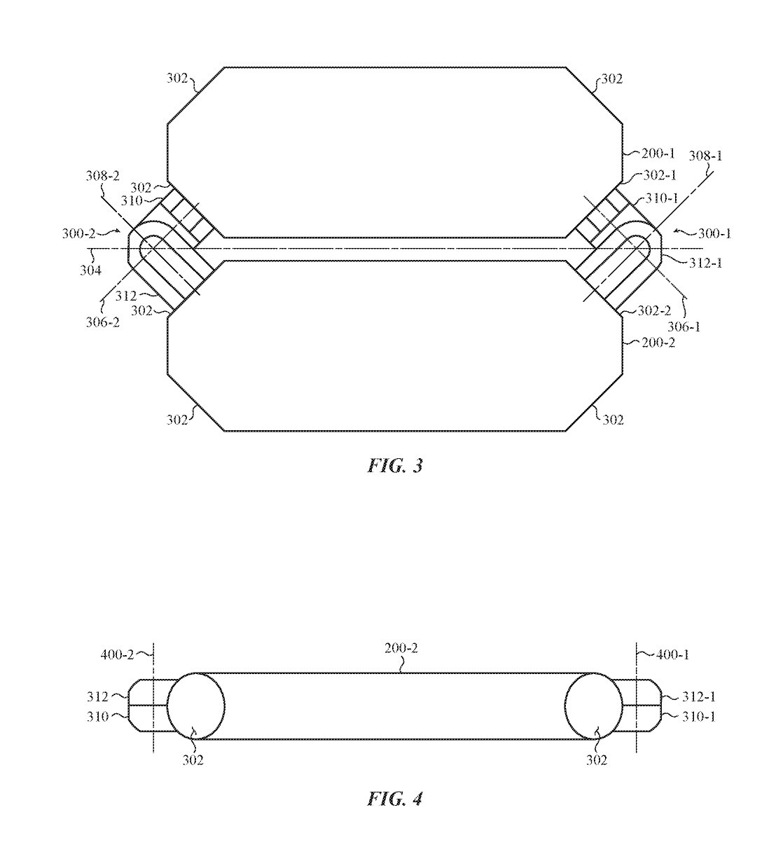

FIG. 2 is a perspective view of the device 100 showing a portion of the band 104, which comprises a plurality of link bodies 200 (also referred to as “links 200”). At least one of the links 200 is coupled to the housing 102, and the links 200 are coupled to other links 200 via articulating joints (e.g., the joints 300, FIG. 3) that allow the links 200 to pivot relative to one another. FIG. 2 shows the links 200 in an articulated orientation, such as may occur when the band 104 is coupled to a wearer's wrist.

FIG. 3 is a top view of a first link 200-1 and an adjacent second link 200-2. The first link 200-1 is set apart from the second link 200-2 by a gap, and is joined to the second link 200-2 by a pair of articulating joints 300-1, 300-2. While FIG. 3 illustrates one pair of links 200, it will be understood that the description of these links may apply to each pair of links 200 in the band 104, or any subset of the links 200 in the band 104.

Each link body 200 includes facets 302 to which the joints 300 are pivotally coupled. For example, with respect to the joint 300-1, a first end of a first arm 310-1 is pivotally coupled to a facet 302-1 of the first link 200-1. Similarly, a first end of a second arm 312-1 of the joint 300-1 is pivotally coupled to a facet 302-2 of the second link 200-2. The joints 300 are pivotally coupled to the facets 302 in any appropriate manner. For example, a post or other protrusion of a joint 300 may extend into an opening in a facet 302. As another example, a post or other protrusion may extend from a facet 302 into an arm of a joint 300. As yet another example, a pin, rod, shaft, screw, bolt, or other component may extend into and/or through openings in both a facet 302 and an arm of a joint 300.

The links 200 are shown having four facets 302, and are coupled to each adjacent link by a pair of joints 300. However, this is merely one example configuration. In some cases, links 200 may include more or fewer than four facets, and/or may be coupled to adjacent links by more or fewer than two joints 300.

The first arm 310-1 of the joint 300-1 is configured to pivot with respect to the first link 200-1 about a first pivot axis 306-1 (also referred to as “pivot axis 306-1”), and the second arm 312-1 is configured to pivot with respect to the second link 200-2 about a second pivot axis 308-1 (also referred to as “pivot axis 308-1”). The respective pivot axes about which the arms rotate may be perpendicular to the respective facets to which the arms are pivotally coupled. For example, the pivot axis 306-1 may be perpendicular to the facet 302-1, and the pivot axis 308-1 may be perpendicular to the facet 302-2. Moreover, the pivot axis 306-1 may be perpendicular to the pivot axis 308-1.

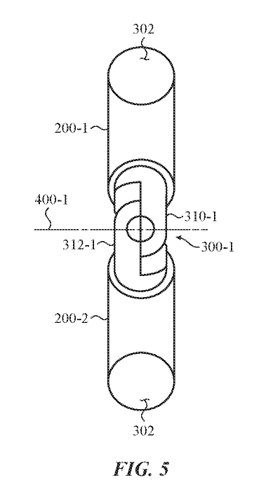

The first arm 310-1 of the joint 300-1 is also pivotally coupled to the second arm 312-1 of the joint 300-1. For example, FIG. 4 shows a front view of the links 200-1, 200-2 of FIG. 3, illustrating a third pivot axis 400 (also referred to as “pivot axis 400”) about which the first and second arms 310, 312 of the joints 300 pivot. FIG. 5 shows a side view of the links 200-1, 200-2 of FIG. 3, showing the orientation of the pivot axis 400-1 with respect to the joint 300-1.

The pivot axes 306, 308, and 400 of a given joint 300 are different from one another, and may not be parallel or coincident with one another. For example, as shown in FIGS. 3-5, when the first and second links 200-1, 200-2 are oriented in the same plane (e.g., when they are not articulated or pivoted relative to one another), the pivot axes 306, 308, and 400 of a given joint 300 are perpendicular to each other. This is merely one example of possible orientations of the pivot axes that are possible, and the pivot axes may be oriented with respect to each other in any suitable manner. Moreover, the relative orientations of the pivot axes 306, 308, and 400 of a given joint may change when the links that the joint is coupled to are articulated. Any such changes are constrained and/or defined by the shapes, angles, and general configuration of the joints 300. In other words, the perpendicular arrangement of the pivot axes 306, 308, and 400 when the links 200-1, 200-2 are oriented in the same plane defines one example joint 300, despite the fact that the relative orientations of the pivot axes 306, 308, and 400 may change during articulation of the joint 300.

The combined effect of the joints 300 being able to pivot about the pivot axes 306, 308, and 400 allows the joints 300 to articulate, in turn allowing the links 200-1, 200-2 to pivot relative to each other about a link pivot axis, which may be a virtual pivot axis 304 (FIG. 3). The virtual pivot axis 304 is different from and is not coincident with or parallel to any of the pivot axes of the joints 300 (e.g., pivot axes 306, 308, 400), and may extend through a space or gap between the first link 200-1 and the second link 200-2. Moreover, in the example shown in FIGS. 3-5, the virtual pivot axis 304 does not pass through any portion of the link bodies 200. In other words, the virtual pivot axis 304 does not correspond to (e.g., is not coincident with or parallel to) a pivot axis of a mechanical pivot (e.g., a pivot pin extending through aligned or collinear openings in the link bodies), but rather is the product of multiple pivoting couplings, none of which pivot about the virtual pivot axis 304.

The facets 302 of the link bodies 200 may form any appropriate angle with respect to the pivot axes 306, 308, 400, and/or the virtual pivot axis 304. For example, the facets 302 may each define or generally correspond to a plane that is angled 45 degrees with respect to the virtual pivot axis 304. (Also, the pivot axes 306, 308 may be angled 45 degrees with respect to the virtual pivot axis 304, regardless of whether the link bodies 200 include facets.) Moreover, facets 302 may define or generally correspond to planes that are perpendicular to corresponding facets 302 on adjacent links 200. For example, the first facet 302-1 may be perpendicular to the second facet 302-2.

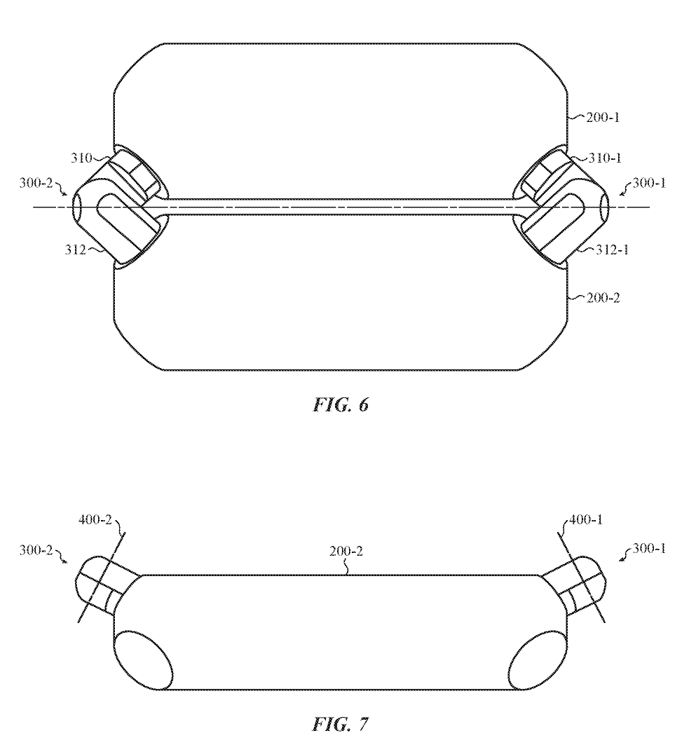

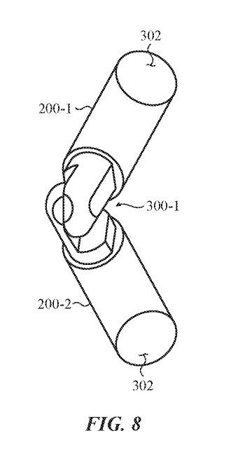

FIGS. 6, 7, and 8 are top, front, and side views, respectively, of the first and second links 200-1, 200-2, showing the links 200-1, 200-2 pivoted with respect to one another about the virtual pivot axis 304. In particular, the first and second links 200-1, 200-2 are shown in a configuration that may result from a wearer applying the band 104 to their wrist or other body part or object, causing the band 104 to flex to conform to the contours of the wearer. In order to allow the first and second links 200-1, 200-2 to pivot about the virtual pivot axis 304, each joint 300 coupling the first and second links 200-1, 200-2 may undergo a pivoting motion about each of its pivot axes. For example, the first arm 310-1 may pivot relative to the first link 200-1 about the pivot axis 306-1 (FIG. 3), the second arm 312-1 may pivot relative to the second link 200-2 about the pivot axis 308-1 (FIG. 3), and the first and second arms 310-1, 312-2 may pivot relative to one another about the pivot axis 400-1. For the first and second links 200-1, 200-2, the three pivoting movements are also mirrored for the second joint 300-2. The pivoting movements result in the articulation of the joints 300 and the pivoting of the links 200-1, 200-2 (as shown in FIGS. 6-8).

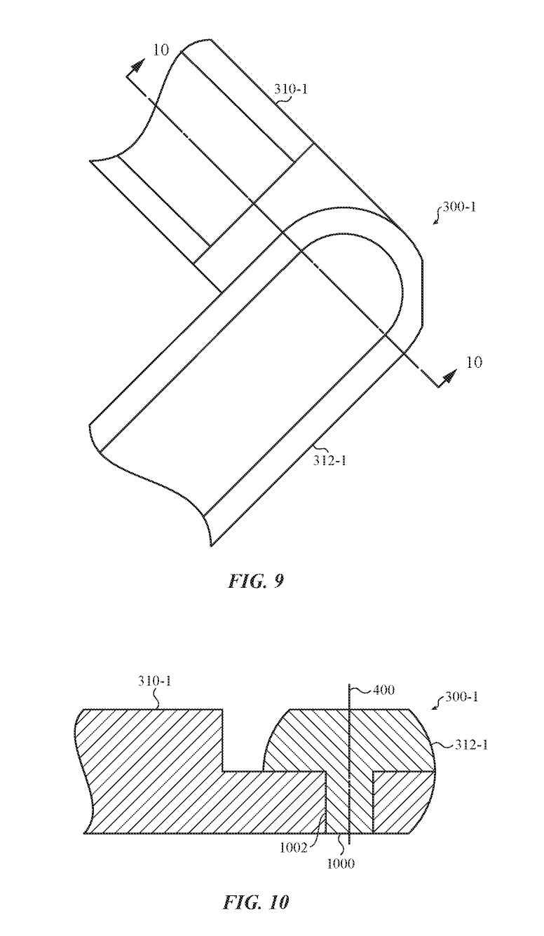

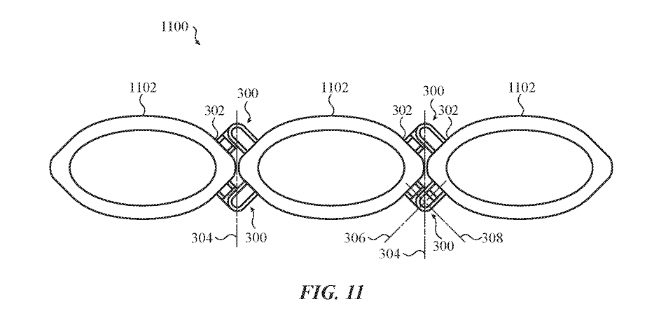

FIG. 9 is an expanded partial view of the joint 300-1, showing the joint 300-1 in a configuration corresponding to the links 200-1, 200-2 in an un-articulated orientation (e.g., the first link 200-1 is in the same plane as the second link 200-2, as shown in FIGS. 3-5). FIG. 10 is a cross-sectional view of the joint 300-1 viewed along line 10-10 in FIG. 9, showing an example coupling mechanism between the first arm 310-1 and the second arm 312-1.

The first arm 310-1 includes an opening 1002. As shown, the opening 1002 is a cylindrical-walled through-hole extending through a portion of the first arm 310-1, but other configurations are also possible. For example, the opening 1002 may be a blind hole, or may include contours, angled walls, undercuts, or other profiles or features. The second arm 312-1 includes a post 1000 that protrudes into the opening 1002 and forms the pivoting coupling between the first arm 310-1 and the second arm 312-1. The post 1000 and opening 1002 allow the first and second arms 310-1, 312-1 to pivot relative to one another about the pivot axis 400.

The second arm 312-1 may be retained to the first arm 310-1 in any appropriate manner. For example, the post 1000 may include a flange (not shown) at a distal end of the post 1000 that engages with an undercut, counter-bore, or other feature (not shown) of the first arm 310-1. For example, a distal end of the post 1000 may be mushroomed, expanded, or otherwise deformed after the post 1000 is disposed in the opening 1002 to form a retention feature. The retention feature engages with the first arm 310-1 to retain the first and second arms 310-1, 312-1 together. Other components and/or features (not shown) may also be included in the coupling mechanism between the first and second arms 310-1, 312-1 to retain the arms to one another, to improve or facilitate pivoting, or the like. For example, bushings, bearings, sleeves, screws, bolts, magnets, welds, caps, pins, tabs, adhesives, or the like may be included in the coupling mechanism. Similar coupling mechanisms may be used to pivotally couple the arms 310, 312 of a respective joint 300 to a respective facet 302 of a link body 200.

While one example joint configuration is described herein, other joint configurations and/or mechanisms may be used instead of or in addition to that shown. For example, while the coupling between the first arm 310 and the second arm 312 of a respective joint 300 is a single pivot that allows one degree of rotational freedom between the first arm 310 and the second arm 312, joints having additional pivots, linkages, or couplings (and thus that allow for more or different articulations, rotations, or translations) may be used. For example, the first arm 310 and the second arm 312 may be coupled via a universal joint, a clevis joint, a telescoping joint, or the like.

Flexible mechanisms or elements may replace some or all of the components of the joints 300 described herein. For example, instead of providing a pivoting coupling between two arms, an arm formed from a single piece of flexible material may be used. The flexible material may deform and/or bend in order to allow the links to pivot about a virtual pivot axis.

Such flexible mechanisms or elements may be formed from any appropriate material, such as a material that can be repeatedly deformed (without yielding or undergoing plastic deformation) to a degree that allows satisfactory flexibility of the band 104. Such materials may include high-strain metals, amorphous metals, shape-memory metals, superelastic metals, and pseudoelastic metals. For example, the joints 300 may be formed from a nickel-titanium alloy (e.g., Nitinol) or a beta-titanium alloy. A joint 300 formed from a flexible material, such as a flexible metal, may allow the links to deflect up to 25 degrees, up to 35 degrees, or up to 45 degrees (or more) relative to one another without damaging or permanently deforming the flexible material.

FIGS. 1-10 illustrate a band 104 that includes link bodies 200 of one example shape. Other shapes are also possible. For example, FIG. 11 shows a portion of a band 1100 having link bodies 1102 that are continuous loops defining an opening. This shape may be selected for aesthetic and/or functional reasons. For example, the link bodies 1102 may be lighter and/or more flexible than other link shapes (e.g., the link bodies 200).

The link bodies 1102 are coupled to adjacent link bodies by a pair of joints 300, as described above with respect to FIGS. 3-10. The link bodies 1102 may include facets 302. Regardless of whether the link bodies 1102 include facets 302, the arms of the joints 300 may be coupled to the link bodies 1102 such that the pivot axes 306, 308 about which the first and second arms of the joints 300 rotate with respect to the link bodies 1102 are perpendicular to each other, and are likewise perpendicular to the pivot axis 400 (FIG. 4). The joints 300 in the band thus allow the link bodies 1102 to pivot relative to one another about a virtual pivot axis 304, as described above. Any other appropriate link shape may be used with the joints 300.

In the foregoing description, the physical orientations of certain structures are described as forming certain angles with respect to other structures. Unless otherwise noted, the angles correspond to a coplanar or unarticulated orientation of the links 200. Moreover, these angles described are merely examples. Indeed, joints that enable links to pivot about a virtual pivot axis may have pivot axes that are not perpendicular to each other when the links are coplanar. Moreover, the angles described are intended to include minor deviations and manufacturing tolerances, and are not limited to exact angles. For example, deviations of up to +/−2 degrees (or more) may be tolerated and are within the scope of the embodiments presented herein.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A band for a wearable electronic device, comprising:
a first link body;
a second link body; and
a pair of joints joining the first link body to the second link body;
each joint comprising:
a first arm pivotally coupled to the first link body at a first end of the first arm; and
a second arm pivotally coupled to the second link body at a first end of the second arm; wherein
a second end of the first arm is pivotally coupled to a second end of the second arm.

2. The band of claim 1, wherein:
the band is coupled to a wearable electronic device;
the first link body and the second link body form part of the band; and
the first link body articulates relative to the second link body to conform the band to a wrist.

3. The band of claim 1, wherein:
the first arm is configured to pivot relative to the first link body about a first pivot axis;
the second arm is configured to pivot relative to the second link body about a second pivot axis perpendicular to the first pivot axis; and
the first arm is configured to pivot relative to the second arm about a third pivot axis perpendicular to the first and second pivot axes.

4. The band of claim 3, wherein:
each link body comprises four facets;
each facet of the four facets is coupled to a respective joint;
a first facet of the first link body is perpendicular to the first pivot axis; and
a second facet of the second link body is perpendicular to the second pivot axis.

5. The band of claim 3, wherein:
the first link body pivots relative to the second link body about a fourth pivot axis different from the first, second, and third pivot axes; and
the fourth pivot axis is a virtual pivot axis.

6. The band of claim 5, wherein:
each link body comprises four facets; and
each facet of the four facets defines a plane that is angled 45 degrees with respect to the fourth pivot axis.

7. The band of claim 1, wherein each link body defines a continuous loop.

8. A wearable electronic device, comprising:
an electronic device housing; and
a band connected to the electronic device housing, the band comprising:
a first link configured to pivot relative to a second link about a link pivot axis;
a first pair of arms pivotally coupled to the first link, each respective arm of the first pair of arms configured to pivot relative to the first link about a respective joint pivot axis that is not parallel to the link pivot axis; and
a second pair of arms pivotally coupled to the second link, each respective arm of the second pair of arms pivotally coupled to a respective arm of the first pair of arms to couple the first link to the second link.

9. The wearable electronic device of claim 8, wherein:
each respective joint pivot axis is a respective first joint pivot axis; and
each respective arm of the second pair of arms is configured to pivot relative to the second link about a respective second joint pivot axis that is not parallel to the link pivot axis.

10. The wearable electronic device of claim 9, wherein each respective arm of the second pair of arms is configured to pivot relative to a respective arm of the first pair of arms about a respective third joint pivot axis that is not parallel to the link pivot axis.

11. The wearable electronic device of claim 10, wherein the respective first, second, and third joint pivot axes are perpendicular to each other.

12. The wearable electronic device of claim 8, wherein the link pivot axis extends through a space between the first and second links.

13. The wearable electronic device of claim 8, wherein the wearable electronic device is a watch.

14. A band for a wearable electronic device, comprising:
a first link body;
a second link body set apart from the first link body by a gap; and
a pair of articulating joints coupling the first link body to the second link body and configured to allow the first link body to pivot relative to the second link body about a pivot axis passing through the gap.

15. The band of claim 14, wherein each articulating joint comprises:
a first arm; and
a second arm coupled to the first arm and having at least one degree of rotational freedom with respect to the first arm.

16. The band of claim 15, wherein:
the pivot axis is a first pivot axis; and
the first and second arms are configured to pivot with respect to one another about a second pivot axis that is perpendicular to the first pivot axis.

17. The band of claim 14, wherein the pivot axis does not pass through the first or the second link body.

18. The band of claim 14, wherein each flexible mechanism of the pair of flexible mechanisms comprises a universal joint.

19. The band of claim 14, wherein each flexible mechanism of the pair of flexible mechanisms comprises a clevis joint.

20. The band of claim 14, wherein the pivot axis is not coincident with a mechanical pivot.
